(19) United States
(12) Patent Application Publication
(10) Pub. No.: US 2019/0337669 A1
(43) Pub. Date: Nov. 7, 2019

(54) PACKAGING CONTAINER FOR LICENSE PLATES; METHOD FOR OPERATING AN EMBOSSING PRESS USING THE PACKAGING CONTAINER; AND EMBOSSING PRESS

(71) Applicant: ERICH UTSCH AG, Siegen (DE)

(72) Inventors: Thomas WOLLENWEBER, Siegen (DE); Jörg KÖLSCH, Wilnsdorf (DE)

(21) Appl. No.: 16/071,756

(22) PCT Filed: Oct. 21, 2016
(86) PCT No.: PCT/EP2016/075372

§ 371 Date: Jul. 20, 2018

(30) Foreign Application Priority Data
Jan. 20, 2016 (DE) 10 2016 100 929.6

(51) Int. Cl. B65D 5/42; B44B 5/00

(52) U.S. Cl. CPC B65D 5/4216; B65D 2203/06; B44B 5/0095; B44B 5/0052

(57) ABSTRACT

The invention relates to a packing container for accommodating number plate panels, wherein each number plate panel is provided with a panel identification means which unambiguously identifies it, which can be detected opto-electronically and in which information about the number plate panel is encrypted. According to the invention, at least two number plate panels are accommodated in the packing container, and the packing container is provided with a container identification means in which the information respectively encrypted in the panel identification means of the at least two number plate panels is recorded at least partially.

The invention further relates to a method for operating an embossing press configured for embossing number plate panels, using such a packing container.

### TECHNICAL FIELD

The disclosure relates to a packing container for accommodating number plate panels. Here, each number plate panel is provided with a panel identification means which unambiguously identifies it, which can be detected opto-electronically and in which information about the number plate panel is encrypted.

The disclosure further relates to a method for operating an embossing press using such a packing container and to an associated embossing press.

### BACKGROUND

In the field of the production of vehicle number plates, embossing presses are known with which a certain number plate legend in the form of, for example, letters and digits are embossed into a number plate blank and then colored in another machine. The number plate blanks used in the process are also referred to as number plate panels and usually already have the desired format and, optionally, further features such as, for example, a raised peripheral edge, country-specific printing, security features etc. If a certain number plate legend is allocated to a vehicle, the former is individually incorporated into a number plate panel.

The legend is then embossed in a raised manner into the panel in the embossing press. For this purpose, a number plate panel is placed in the embossing press. The alphanumerical embossing tools in the form of so-called block tools, which are required for embossing, are manually laid into a drawer by an operator, for example, and pushed into the embossing press together with the panel. Then, the embossing press is able to carry out the embossing process for a certain number plate legend. Such an embossing press in combination with a machine for subsequently coloring the legend is known, for example, from EP 1 207 082 B1.

Such embossing presses may be used, in particular, in vehicle registration offices, where an operator receives from a person a vehicle office processing slip on which the number plate legend to be embossed is indicated. Such an embossing job may also be transmitted to an operator of an embossing press via the internet or other data connections. In order to manage number plate panels in such an overall system, it is known, for example, to provide them with identification means, such as serial numbers in plain text, or also in the form of barcodes.

However, manual errors may occur during the embossing process, for example, when the operator does not insert the proper block tools or uses a wrong panel. Moreover, tampering may take place if attempts are made to apply a certain legend allocated by the vehicle office to several number plate panels. It is therefore also known to transmit an embossing job to an embossing press electronically, whereby the information required for the necessary embossing process can be stored in the embossing press. In that case, a variety of information may be shown to an operator on a monitor, for example, in order to avoid embossing errors. However, errors and even tampering cannot be completely prevented in this way.

### SUMMARY

The disclosure therefore provides a type of use of number plate panels in an embossing press with which errors and tampering can be prevented better.

The disclosure provides a packing container for number plate panels, wherein each number plate panel is provided with a panel identification means which unambiguously identifies each number plate panel, the panel identification means is configured to be detected opto-electronically and in which information about the number plate panel is encrypted, wherein at least two number plate panels are accommodated in the packing container, and the packing container is provided with a container identification means in which the information respectively encrypted in the panel identification means of the at least two number plate panels is recorded at least partially. Advantageous embodiments of this packing container are apparent from the dependent claims. Furthermore, the disclosure provides a method for operating an embossing press including at least the following steps: detecting the container identification means of the packing container by means of a scanning device of the embossing press; and reading out information concerning the number plate panels from the detected container identification means by means of a control unit of the embossing press and storing this information, with advantageous developments of this method being apparent from the dependent claims, and an associated embossing press for embossing number plate panels using the disclosed packing container for accommodating number plate panels wherein the embossing press is configured for carrying out the disclosed method.

The packing container according to the disclosure serves for accommodating number plate panels, wherein each number plate panel is provided with a panel identification means which unambiguously identifies it. This panel identification means can be detected opto-electronically, and information about the respective number plate panel is encrypted in it. According to the disclosure, at least two of these number plate panels are accommodated in the packing container, and the packing container is provided with a container identification means in which the information respectively encrypted in the panel identification means of the at least two number plate panels is recorded at least partially. Preferably, this information is recorded in the container identification means in an encrypted manner.

The packing container may be any container or casing acting as a container, which is suitable for accommodating several number plate panels. In this case, the container can be configured in a completely closed or also only partially closed manner. For example, it may be formed by a cardboard box, a film wrap, a pallet, etc. Several number plate pallets with respective panel identification means may thus be put into a cardboard box and the cardboard box can be provided with a container identification means. Several number plate panels may also be wrapped with a film and the film may be provided with a container identification means. The same also applies to a pallet on which several number plate panels are placed and then wrapped with a film.

However, these examples are not to be understood as limiting; rather, the disclosure extends to any type of container or transport means with which, in particular several, number plate panels can be transported to an embossing press together prior to being used there individually for embossing processes based on embossing jobs for number plate legends.

In this case, the packing container according to the disclosure is advantageous in that, by reading out a single container identification means, all admissible panel identification means of number plate panels in a single packing can be detected and recorded, for example, in the embossing press. These detected panel identification means may then be transmitted from the embossing press to a central management unit in order to transmit information about the number plate panel to be used to it. In an overall system, the embossing press would then be offline at least temporarily in order to exchange information with other components of the system. Such a system could at least include several embossing presses and a central management unit, wherein the data of the central management unit could be used for monitoring and authenticating embossing processes at the individual embossing presses.

However, the disclosure can be used particularly advantageously if an embossing press is supposed to be able also to operate offline, i.e. without a connection to other components of an overall system. In order to verify number plate panels based on their panel identification means and enable an embossing process only if the inserted number plate panel is an admissible number plate panel, the embossing press should be provided with information about admissible number plate panels. In that case, the embossing press need not be connected to a central database, for example, in which this information is stored for the overall system. Rather, this can be realized with the packing container according to the disclosure, in whose container identification means information concerning admissible panel identification means is stored. If this information is read out at the embossing press and stored in the embossing press, it may be used for subsequently verifying the panel identification means of number plate panels introduced into the embossing press.

In the case of an opto-electronically detectable panel identification means, this may be, in the simplest form, a one-dimensional barcode, for example. Preferably, however, a two-dimensional data matrix code is used in each case as a panel identification means of a number plate panel and/or as a container identification means of a packing container. Such a data matrix code is herein after also referred to, in an abbreviated form, as DMC. It has the advantage of having a very high information density because much information can be encrypted in a small space. This is advantageous particularly if a panel identification means is to be applied as unobtrusively as possible on a number plate panel. Further, the DMC has a high level of data safety, because even if about 25% of the data are destroyed or are invisible to a scanning device, the DMC can still be read out.

In order to increase security against tampering, a preferred embodiment of the disclosure provides that information about number plate panels is encrypted in a container identification means with a symmetric and/or asymmetric encryption. In the process, both types of encryption may be used separately or also in combination. The use of an asymmetric encryption may provide, for example, that the information, when generated, is encrypted in the container identification means with a public key. The information, when reading out the container identification means at the embossing press, may then be decrypted with a secret key (private key) known to the embossing press.

In order to further enhance security, this asymmetric encryption may be supplemented with a symmetric encryption. When generating the container identification means, for example, a private key may be generated and used, with which the information in the container identification means is encrypted. This private key is recorded in the container identification means so that it can be read out after the decryption of the asymmetric encryption in order to decrypt the symmetric encryption of the information with it.

Furthermore, a container identifier, with which the packing container is unambiguously identifiable, can be recorded or also encrypted in the container identification means. This encryption may also include a symmetric and/or asymmetric encryption, or the container identifier is merely encrypted in the data matrix of the data matrix code. The container identifier may also be used for verification purposes in order to verify, when reading out the container identification means at the embossing press, whether this is an admissible container.

Information about this number plate panel with different character lengths may be contained in the panel identification means of a number plate panel. In that case, a DMC has a corresponding size depending on the characters represented in it. This information about a respective number plate panel may include, in particular, a serial number with which the number plate panel is unambiguously identifiable in the system. Furthermore, information such as production data, the format of the panel etc. may also be included. In order to keep the size of a DMC relatively small, character lengths in the range of 10-20, in particular of 16, have proved advantageous. However, any other character lengths may also be chosen.

In the process, not all characters need be used for information about a number plate panel; rather, some characters may be used for other purposes. For example, some characters may be formed by a hash function of other characters. These hash values may be used for verification purposes, for example, in order to carry out an integrity verification.

In one embodiment of the disclosure, for example, the information about a number plate panel encrypted in a panel identification means at least comprises a first string with n characters and a second string with m characters, wherein the n characters of the first string are mapped by a hash function to the m characters of the second string. In particular, it may be provided that only the n characters of the first string are recorded or encrypted in the container identification means. This is advantageous, in particular, in that the dimensions of the container identification means is reduced as compared with the encryption of all characters of the several panel identification means of a packing container.

The disclosure further comprises a method for operating an embossing press configured for embossing number plate panels using a packing container according to one or more of the above-described embodiments. The method is characterized by at least the following steps:
a) Detecting the container identification means of the packing container by means of a scanning device of the embossing press;
b) Reading out information concerning the number plate panels from the detected container identification means by means of a control unit of the embossing press and storing this information.

With this method, based on a container identification means of a packing container, all panel identification means of number plate panel contained therein can thus be read out at an embossing press and stored. Before an operator is able to remove number plate panels from a packing container in order to use them for embossing jobs, he must therefore detect the container identification means of the container. The panel identification means detected in this manner may be used advantageously in various manners. In particular, they may be used for verifying the admissibility of number plate panels, which are then inserted by an operator into the embossing press for an embossing job.

In the process, the information in step b) may be stored in a storage unit of the embossing press or a component remote from the embossing press, wherein an at least temporary communication link between the embossing press and this component is existent. The verification of number plate panels inserted by an operator into the embossing press for an embossing job may be carried out by the embossing press itself in the first embodiment, whereas the verification in the second embodiment may also be carried out by said second component.

A container identification means may be detected, for example, by a handheld scanner connected to a control unit of the embossing press. In the case of container identification means in the form of data matrix code, a camera taking an image of the DMC is used as a scanning device. This image is transmitted to the control unit of the embossing press, which is able to read out information from the container identification means with a software. In the process, the above-mentioned decryptions may take place in order to finally be able to obtain and store the information about all number plate panels in the packing container.

The method may be supplemented with the steps
c) Detecting a panel identification means from a number plate panel;
d) Reading out the information about this number plate panel from the panel identification means by means of the embossing press;
e) Comparing the information about this number plate panel read out in step d) with information about number plate panels stored in the storage unit of the embossing press;
f) Enabling an embossing process on the embossing press if the comparison in step e) shows that the read-out information about this number plate panel matches information about number plate panels stored in the storage unit.

If a number plate panel is to be used for an embossing job by an embossing press, then the panel identification means of the respective panel must first be detected at the embossing press in step d) in order to be able to read out information about the panel. This may also be done by the operator and a handheld scanner. However, detection may also take place automatically if a number plate panel is inserted into the embossing press. A camera may also be used as a scanning device in this case, whose image of a DMC is transmitted to the control unit of the embossing press in order to read out information from it about the respective number plate panel.

The information read out in this manner is then compared with the information about admissible number plate panels of a packing container which was previously detected by means of a container identification means and stored in the embossing press. Only if this comparison shows that the read-out information matches information about number plate panels stored in the storage unit is the embossing process enabled. Otherwise, the embossing process is blocked, because the detected panel identification means is in this case an inadmissible number plate panel. The panel may be inadmissible, for example, because it is not an admissible panel in principle. This may be the case if only number plate panels of a certain manufacturer are to be used in an embossing press, but the number plate panel does not belong to this group. A panel may also be inadmissible if it is a number plate panel of a certain manufacturer but if this panel was already used once for an embossing process or was already detected once at the embossing press. This suggests an attempt at tampering which is prevented by blocking the embossing process.

In order to discover number plate panels that were used already based on a comparison with stored information, the information of used number plate panels must be labeled accordingly, for example, in the storage unit of the embossing press. In this case, a use of a number plate panel means that its panel identification means was detected once for an embossing process at the embossing press. In one embodiment of the disclosure, it is then provided that the information respectively stored in the storage unit of the embossing press is labeled as used if an embossing process is enabled in step f). In this case, various measures may be taken for labeling. For example, the information concerned may be provided with a labeling, wherein only the information that does not have such a labeling is used for the comparison in step f). Information concerning number plate panels not yet used may, however, also be provided with a labeling from the start, which is deleted once a number plate panel has been used. Only the information that still has such a labeling is in that case used for the comparison in step f). A complete deletion of information concerning used number plate panels is also possible, so that only the information that is still present, i.e. whose associated number plate panels were not yet used, is used in the comparison in step f).

If panel identification means are used in which a string does not only comprise information concerning a number plate panel, but also of hash values concerning this information, then, in step b), prior to storing the information, a hash function is also generated from the n characters of the first group of characters of read-out information about the number plate panel and stored. The hash values thus obtained may then be compared with the hash values from a panel identification means read out from a number plate panel, for an integrity verification.

This method can be carried out on an embossing press configured accordingly. In particular, such an embossing press may thus be configured for
Detecting the container identification means of the packing container by means of a scanning device of the embossing press;
Reading out information concerning the number plate panels from the detected container identification means by means of a control unit of the embossing press and storing this information in a storage unit of the embossing press.

In addition, the embossing press is preferably configured for
Detecting a panel identification means from a number plate panel;
Reading out the information about this number plate panel from the panel identification means by means of the embossing press;
Comparing the read-out information about this number plate panel with information about number plate panels stored in the storage unit of the embossing press;
Enabling an embossing process on the embossing press if the comparison shows that the read-out information about this number plate panel matches information about number plate panels stored in the storage unit.

In another embodiment of the disclosure, the embossing press is configured for labeling the information respectively stored in the storage unit as used if an embossing process is enabled. It may further be configured to generate a hash function from the n characters of the first group of characters of the read-out information about the number plate panel and store it prior to storing the information from the detection of a container identification means.

Such an embossing press is very safe from tampering, but at the same time simple to operate by a user. Furthermore, it may also be operated offline, without a connection to databases in which information about admissible number plate panels is stored, because the information required for this purpose can be provided through reading out the container identification means of a packing container for several number plate panels at the embossing press.

### BRIEF DESCRIPTION OF THE DRAWINGS

Other advantages, special features and expedient further developments of the disclosure are apparent from the dependent claims and the following presentation of preferred embodiments with reference to the illustrations.

In the drawings:

FIG. 1 shows an illustration of the front of a number plate panel;

FIG. 2 shows an illustration of the rear of a number plate panel according to FIG. 1 with a data matrix code;

FIG. 3 shows a schematic cross section through an embodiment of a packing container according to the disclosure;

FIG. 4 shows a plan view of a packing container with a data matrix code;

FIG. 5 shows a schematic cross section through an embodiment of an embossing press; and

FIG. 6 shows the insertion of a number plate panel into an embossing press according to FIG. 5.

### DETAILED DESCRIPTION OF THE DRAWINGS

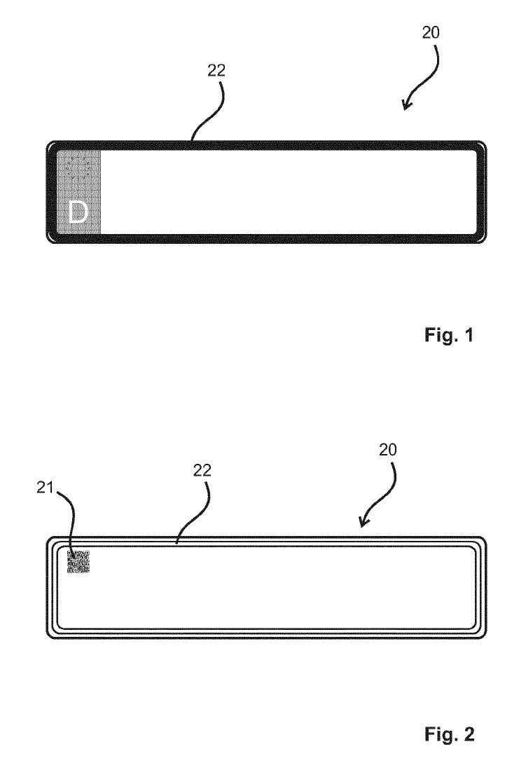

The front of a number plate panel 20 illustrated in FIG. 1 shows a possible embodiment of such a panel by way of example. In this exemplary embodiment, it has an elongate, rectangular shape. However, other formats with other aspect ratios are also possible. The panel 20 comprises a sheet metal strip, wherein an aluminum alloy may be chosen as the material, for example. A peripheral edge 22, which is configured to be raised at the front and printed with color, is already embossed into this sheet metal strip. Additional color printing, which is also only to be understood as an example, is applied to the left-hand area of the panel. On the whole, the number plate panel may have different country-specific designs.

The embossed edge is apparent from the rear, as is the printed identification feature 21, on the rear of the number plate panel 20 shown in FIG. 2. This is a two-dimensional data matrix code (DMC) of a type known per se. This DMC is applied to, for example, a corner of the panel 20 and can be detected with a scanning device in order to read out the data encrypted therein. In this case, the DMC may be printed on or applied by laser.

A variety of information concerning the respective number plate panel may be encrypted in the data matrix code 21 of a number plate panel 20, which is hereinafter also referred to as a plate-DMC. This may be, in particular, a serial number with which the number plate panel is unambiguously identifiable in an overall system. Furthermore, information such as production data, the format or similar data may also be included. The plate-DMC 21 can be detected with a scanning device such as a camera, wherein the encrypted information can be read out with a corresponding software from the image of the camera.

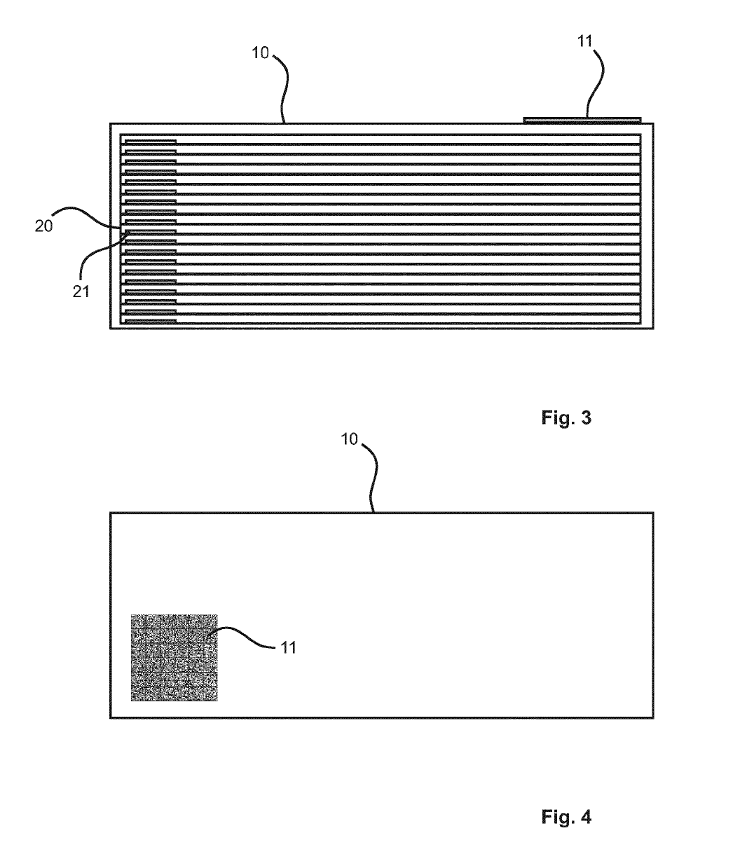

The illustration of FIG. 3 schematically shows a cross section through an embodiment of a packing container 10 according to the disclosure. This is a simple cuboid container, for example in the shape of a cardboard box. A plurality of number plate panels 20 stacked one above the other is placed in this cardboard box. The number of the panels depends on the capacity of the container, the maximum possible weight or other criteria, so that the illustration of nineteen panels 20 stacked one above the other in the packing container 10 of FIG. 3 is only an example.

In this case, each number plate panel 20 is provided with a panel identification means as it is apparent from FIG. 2 and only schematically indicated in the illustration of FIG. 3. In contrast, the packing container 10 is provided with a container identification means 11, which is preferably firmly assigned to the packing container. Such a box-DMC is apparent from the plan view of a packing container 10 of FIG. 4. This may be, for example, a sticker with a printed code, in particular a data matrix code. However, it may also be an RFID transponder glued onto the container. The container identification means 11 may also be firmly allocated to the container 10 in other ways. For example, it may be an appended sign, a DMC printed on directly, an enclosed slip of paper etc.

The information concerning the respective number plate panels 20 in this packing container 10 are at least partially recorded in the container identification means 11, so that they can be read out. In this case, the recording is preferably done in an encrypted manner, wherein suitable methods may be applied and also combined with each other, depending on the intended level of security. A corresponding decryption then takes place when the information is read out. For example, this may take place at an embossing press at which the number plate panels 20 from a packing container 10 are to be used.

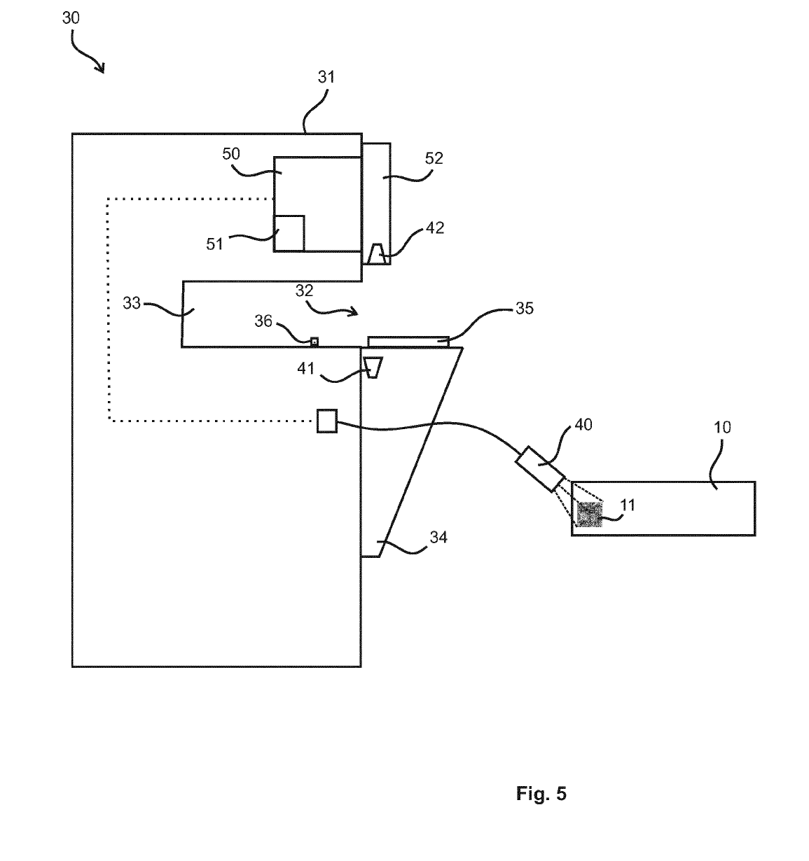

An exemplary embodiment of an embossing press 30, in which a number plate panel 20 can be embossed and provided with a legend in the process, is apparent from the schematic illustration shown in FIG. 5. This is preferably a relatively compact floor-mounted appliance with a housing 31 in which the essential components for embossing the number plate panels are accommodated. These components are not illustrated in detail but are known to the person skilled in the art and may readily be provided depending on the requirements. In particular, they are one or several press plungers with which embossing tools can be pressed into the surface of a panel.

Approximately at the waist level of a user, the device 31 has a housing opening 32 through which number plate panels can be inserted into a schematically indicated embossing chamber 33 within the housing 31. The embossing process takes place within this embossing chamber 31. An outwardly protruding front section 34 is provided underneath the housing opening 32, which forms a support surface in front of the housing opening 32 on which number plate panels can be placed prior to being introduced into the embossing chamber 33. In particular, this support surface is configured as a drawer 35 that can be displaced horizontally. A number plate panel can be prepared on the drawer 35 together with the corresponding embossing tools and then pushed into the housing opening 32. For an embossing job, for example, several embossing tools may be inserted into the drawer 35 and a number plate panel may be placed thereon. After the embossing process within the embossing chamber 33, the embossed number plate on the drawer 35 is pulled out of the embossing press 30 and can be removed in order to color the legend embossed in a raised manner.

A functional unit 52 is mounted above the housing opening 32. The former may be integrated into the housing 32 or attached to the outside of the housing 31, as is provided, for example, by the embodiment of FIG. 5. This functional unit 52 is preferably configured as an operation and display unit, wherein, in particular, a touchscreen may be used for this purpose. Via the functional unit 52, an operator may control the embossing press 30, he may be shown information about embossing jobs, and he may also be shown error messages on this monitor.

The functional unit 52 is connected to a control unit 50 of the embossing press 30. This control unit 50 includes a storage unit 51. The control unit may be connected to other components of an overall system, for example, via a communication line that is not depicted. This may include a central management unit, job components for generating embossing jobs etc. Further, at least one scanning device 40 of the embossing press, with which a container identification means 11 of a packing container 10 can be detected, is connected to the control unit 50. The image of a container identification means 11 thus detected may then be transmitted to a control unit 50 of the embossing press 30 for reading out information. This information may be stored in the storage unit 51 and/or transmitted to a central management unit.

The scanning device 40 is, for example, a handheld scanner with a camera and a cable that by be brought up close to the container identification means 11 of a packing container 10 by an operator. However, the scanning device may also be firmly integrated into the embossing press 30 so that the operator has to hold the packing container in front of the scanning device. This may be disadvantageous in the case of heavy packing containers, so that a freely movable handheld scanner is more advantageous for this case. However, both variants may be realized in an embossing press 30.

In addition, further scanning devices may be provided in order to be able to detect panel identification means of number plate panels inserted into the embossing press 30. The embodiment of an embossing press according to FIG. 5 provides another scanning device 42 at the bottom of the functional unit 52, for example. This is preferably a camera. With this scanning device 42, a panel identification means may be detected from the top of the number plate panel if the latter is placed on the drawer 35. In contrast, another scanning device (camera) 41 in the front section 34 may be used for detecting panel identification means on the bottom of number plate panels.

The scanning devices shown, however, are only to be understood as examples, and any other arrangement and embodiment of scanning devices may be provided in order to detect panel identification means of number plate panels. The advantageous trigger mechanism described hereinafter also does not necessarily have to be provided and configured in this manner.

In order to trigger the automated detection of a panel identification means, a trigger mechanism may be provided which may be triggered by the movement of the number plate panel itself or by the drawer 35. For example, a trigger mechanism 36 may be formed behind the housing opening 32. This may be, for example, a mechanical switch or a light barrier. In the exemplary embodiment of FIG. 5, for example, a light barrier 36 is attached at the level of the drawer 35. As soon as the drawer 35 with a number plate panel located thereon passes the light barrier 36, the trigger mechanism triggers the detection of the panel identification means. In the process, both scanning devices 41 and 42 may be activated, wherein only that image of the scanning device is used on which a panel identification means is located. However, it may also be provided that the embossing press has information about which side of a number plate panel to be embossed a panel identification means is located on. In this way, the embossing press 30 is able to decide which scanning device is triggered. This information about the position of an identification feature may be contained in an embossing job, for example.

If only number plate panels with identification features on one predetermined side of the panels are used, i.e. only on the front or the rear, the disclosure may also be realized with a single scanning device on the corresponding side.

In particular, the trigger mechanism 36 may be configured that it triggers only if the number plate panel has already been partially inserted into the housing opening 32. Furthermore, the trigger mechanism 36 is preferably located within the housing 31, in particular at a position that is difficult to access, in order to also prevent attempts at tampering in the region of the trigger mechanism, if possible.

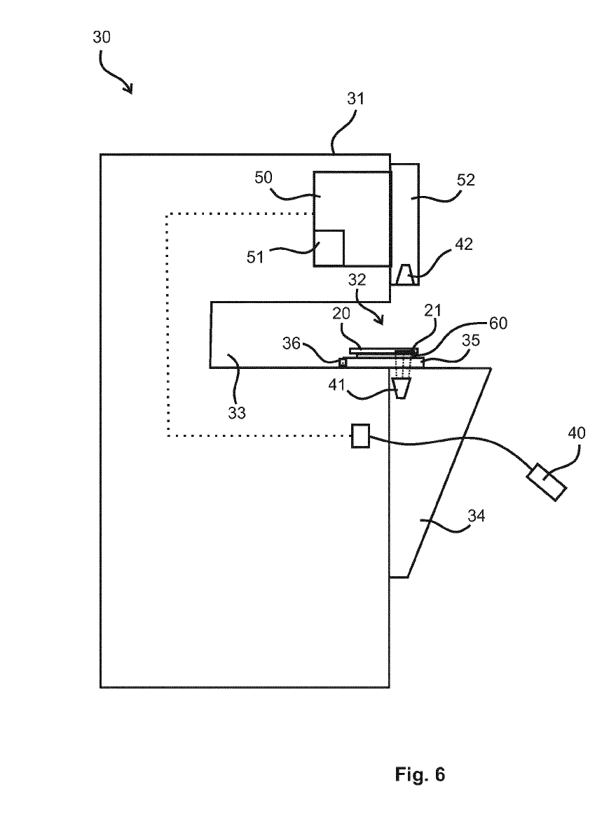

FIG. 6, for example, shows the state when the drawer 35 is pushed into the housing opening 32. A number plate panel 20 with a panel identification means 21 on the bottom and embossing tools 60 which are selected in accordance with a legend to be embossed are located on the drawer 35. The front side of the drawer 35 arrives in the region of the trigger mechanism 36. At that moment, the panel identification means 21 is located above the scanning device 41, so that the latter is able to take an image of the panel identification means 21 from underneath.

Such an embossing press 30 may be used to carry out the method according to the disclosure. If the information concerning number plate panels, which constitute admissible panels for use in the embossing press, is read out from a container identification means and stored, for example, in the storage unit 51 of the embossing press 30, it may be compared with information from panel identification means read out from number plate panels that are being inserted into the embossing press 30. If such a data comparison shows that an inserted number plate panel is not an admissible panel, the embossing process may be blocked or not enabled.

1. A packing container for accommodating number plate panels, wherein each number plate panel is provided with a panel identification means which unambiguously identifies each number plate panel, the panel identification means is configured to be detected optoelectronically and in which information about the number plate panel is encrypted, wherein at least two number plate panels are accommodated in the packing container and the packing container is provided with a container identification means in which the information respectively encrypted in the panel identification means of the at least two number plate panels is recorded at least partially.

2. The packing container according to claim 1,
wherein the panel identification means of the number plate panel or the container identification means of a packing container is a two-dimensional data matrix code.

3. The packing container according to claim 1,
wherein information about the number plate panels is encrypted in a container identification means with a symmetric or asymmetric encryption.

4. The packing container according to claim 1,
wherein a container identifier, with which the packing container is unambiguously identifiable, is recorded in the container identification means.

5. The packing container according to claim 1,
wherein the information about the number plate panel encrypted in the panel identification means at least includes a first string with n characters and a second string with m characters, wherein the n characters of the first string are mapped by a hash function to the m characters of the second string.

6. The packing container according to claim 5,
wherein only the n characters of the first string are recorded in the container identification means.

7. A method for operating an embossing press configured for embossing number plate panels, using a packing container according to claim 1, the method including at least the following steps:
a) detecting the container identification means of the packing container by means of a scanning device of the embossing press;
b) reading out information concerning the number plate panels from the detected container identification means by means of a control unit of the embossing press and storing this information.

8. The method according to claim 7,
wherein the information in step b) is stored in a storage unit of the embossing press.

9. The method according to claim 8,
further including the following steps:
c) detecting a panel identification means from a number plate panel;
d) reading out the information about this number plate panel from the panel identification means by means of the embossing press;
e) comparing the information about this number plate panel read out in step d) with information about number plate panels stored in the storage unit of the embossing press;
f) enabling an embossing process on the embossing press if the comparison in step e) shows that the read-out information about this number plate panel matches information about number plate panels stored in the storage unit.

10. The method according to claim 9,
wherein the information respectively stored in the storage unit of the embossing press is labeled as used if an embossing process is enabled in step f).

11. The method according to claim 7 using a packing container
wherein the information about the number plate panel encrypted in the panel identification means at least includes a first string with n characters and a second string with m characters, wherein the n characters of the first string are mapped by a hash function to the m characters of the second string, wherein only the n characters of the first string are recorded in the container identification means, wherein
in step b), prior to storing the information, a hash function is generated from the n characters of the first group of characters of the read-out information about the number plate panel and stored.

12. An embossing press for embossing number plate panels using a packing container for accommodating number plate panels, wherein each number plate panel is provided with a panel identification means which unambiguously identifies each number plate panel, the panel identification means is configured to be detected opto-electronically and in which information about the number plate panel is encrypted, wherein at least two number plate panels are accommodated in the packing container, and the packing container is provided with a container identification means in which the information respectively encrypted in the panel identification means of the at least two number plate panels is recorded at least partially,
wherein the embossing press is configured for carrying out the method recited in claim 7.
